(19) United States
(12) Patent Application Publication
(10) Pub. No.: US 2007/0104295 A1
(43) Pub. Date: May 10, 2007

(54) RSSI for FSK IQ demodulator

(75) Inventor: Jeffrey J. Kriz, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/271,016

(22) Filed: Nov. 10, 2005

(51) Int. Cl. H04L 27/14

(52) U.S. Cl. 375/334

(57) ABSTRACT

Improved mechanism for generating a receive signal strength indicator (RSSI) in a baseband frequency shift keyed (FSK) demodulator. In one embodiment, the method comprises the steps of (i) receiving inphase and quadrature baseband signals having a relative phase relationship indicative of data symbols; (ii) limiting the amplitude of the inphase and quadrature baseband signals; (iii) generating inphase pulses and quadrature pulses representative of signal amplitude transitions of the inphase and quadrature baseband signals; (iv) generating relative phase pulses representative of the relative phase between the inphase and quadrature baseband signals; (v) generating a data symbol output signal in response to the relative phase pulses; and (vi)generating a receive signal strength indicator signal proportional to the magnitudes of the inphase pulses and quadrature pulses.

### FIELD OF THE INVENTION

The present invention relates to digital demodulators, and measuring the receive signal strength.

### BACKGROUND

Wireless signals in a wireless transmission system are generally affected by the many variables, including the surrounding environment. A wireless receiver may need to take certain actions based on the strength of the received signal. To indicate the strength of a received signal, a receiver signal strength indicator (RSSI) signal is typically generated from a transceiver of the wireless transmission system.

In a certain class of receivers used in digital communications, the receive signal may be limited, or clipped, in order to perform demodulation of the received signal. One such receiver is disclosed in U.S. Pat. No. 5,197,085 entitled “Radio Receiver”, the entire contents of which are hereby incorporated by reference. The demodulator is also described in “A Single-Chip VHF and UHF Receiver for Radio Paging,” Wilson, J. et al., IEEE Journal of Solid-State Circuits, Vol. 26, No. 12, December 1991, also incorporated herein by reference. A block diagram of the receiver 100 is shown in FIG. 1, with the demodulator 102 operating on the inphase (I) and quadrature (Q) signal channels. It is generally recognized that the distortion caused by such limiting destroys the characteristics of the received signal that are indicative of the signal strength, and as such, any desired RSSI measurements must be formed prior to the limiting operation.

Furthermore, many commercially available transceiver devices are self-contained in an integrated circuit package, and do not provide access to signals internal to the receiver or demodulator. Thus, in many cases, it is virtually impossible for a circuit designer to add an external RSSI circuit to a transceiver device that does not already provide one on the integrated circuit.

Consequently, an improvement in generating RSSI measurements is desired.

### SUMMARY

The present invention provides an improved mechanism for generating a receive signal strength indicator (RSSI) in a baseband frequency shift keyed (FSK) demodulator. In the FSK receivers described herein, the down-converted baseband signals on the inphase (I) and quadrature (Q) channels are limited during the demodulation process. The imperfect limiting, or clipping, of the input I and Q signals results in discontinuities, signal leakage and intermodulation components in the clipped signals, represented as high frequency energy within the processed I and Q signals. By high-pass filtering the clipped signals, this energy is extracted in the form of positive and negative pulses or sinusoid fragments occurring at the transition points of the input I and Q signals. Significantly, the degree of clipping affects the nature of the discontinuity, and hence the amount of energy present in the pulses. Therefore, a measure of the magnitude of the pulses may be used as a measure of the receive signal strength.

In one embodiment, the method comprises the steps of (i) receiving inphase and quadrature baseband signals having a relative phase relationship indicative of data symbols; (ii) limiting the amplitude of the inphase and quadrature baseband signals; (iii) generating inphase pulses and quadrature pulses representative of signal amplitude transitions of the inphase and quadrature baseband signals; (iv) generating relative phase pulses representative of the relative phase between the inphase and quadrature baseband signals; (v) generating a data symbol output signal in response to the relative phase pulses; and (vi)generating a receive signal strength indicator signal proportional to the magnitudes of the inphase pulses and quadrature pulses.

There are various signals that may be operated on to form the receive signal strength indicator signal, including the inphase and quadrature pulses, the relative phase pulses, or even the data symbol output signal, which is generally a square wave, but in many demodulators it also contains a voltage ripple signal proportional to the inphase and quadrature pulses. In the embodiments that operate on the data symbol output signal, the data symbol output signal is preferably high-pass filtered to remove the data symbol information, leaving only the voltage ripple.

To obtain the RSSI signal, the pulses are preferably processed by a non-linear circuit such as a rectifier, a squaring amplifier, or mixer. The output of the non-linear circuit is preferably a direct current signal that may then be low pass filtered to determine a measure of the magnitude of the pulses.

In alternative embodiments, an apparatus for generating a receive signal strength measurement is provided. The apparatus preferably includes a frequency shift keyed demodulator that generates a data symbol output signal in response to relative phase pulses representative of the relative phase relationship between inphase and quadrature baseband signals, and a non-linear circuit for generating a receive signal strength indication signal proportional to the magnitude of the relative phase pulses.

The non-linear circuit may be a voltage rectifier, current rectifier, a current or voltage squaring circuit, a mixer, or other circuit that generates a direct current output signal. In addition, the non-linear circuit may include an analog to digital converter, whose output may be collected and processed by a digital signal processor or a digital circuit that performs peak detection or root-mean-square (RMS) detection. The non-linear circuit may operate on inphase and quadrature pulses generated from a clipping operation on the inphase and quadrature channels, relative phase pulses generated from the I and Q phase pulses, or even a square wave data symbol output signal of the demodulator, wherein the square wave data symbol output signal contains a voltage ripple signal proportional to the magnitude of the relative phase pulses.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 is a block diagram depicting functional components of a prior art FSK receiver.

FIG. 2 is a block diagram depicting functional components of a prior art FSK demodulator.

FIG. 3 is a timing diagram depicting aspects of the prior art demodulator of FIG. 2.

FIG. 4 is a block diagram depicting a preferred embodiment of the RSSI signal generation circuit.

FIGS. 5A and 5B are voltage waveform plots of an FSK demodulator output.

FIG. 6 is a graph depicting the operating range of one preferred embodiment of the RSSI signal generator.

### DETAILED DESCRIPTION

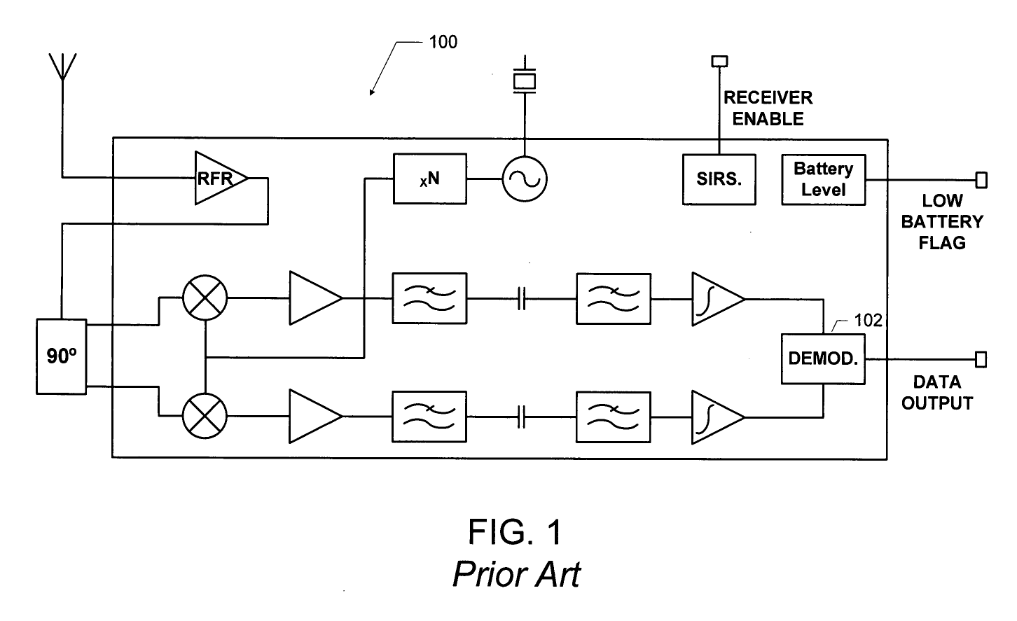

An improved mechanism for generating a receive signal strength indicator (RSSI) in a baseband frequency shift keyed (FSK) demodulator is provided. FIG. 1 depicts a prior art FSK demodulator that may be used with the RSSI signal generator described herein. In the FSK receiver of FIG. 1, the received signal is at a frequency above or below a center frequency, as determined by the data symbol being transmitted. The received signal is mixed with a local oscillator frequency to down-convert it to a zero center frequency. In the process, the signal is decomposed into inphase (I) and quadrature (Q) baseband signals. The down-converted baseband signals on the I and Q channels represent a parametric form of the baseband signal, also typically treated as a complex frequency, with the inphase channel representing a real component, and the quadrature channel representing an imaginary component, as is well known to those of skill in the art. The relative phases of the inphase and quadrature components are determined by whether the received frequency is above the local oscillator frequency (resulting in the I channel phase leading the Q channel phase) or below (resulting in the I channel phase lagging the Q channel phase).

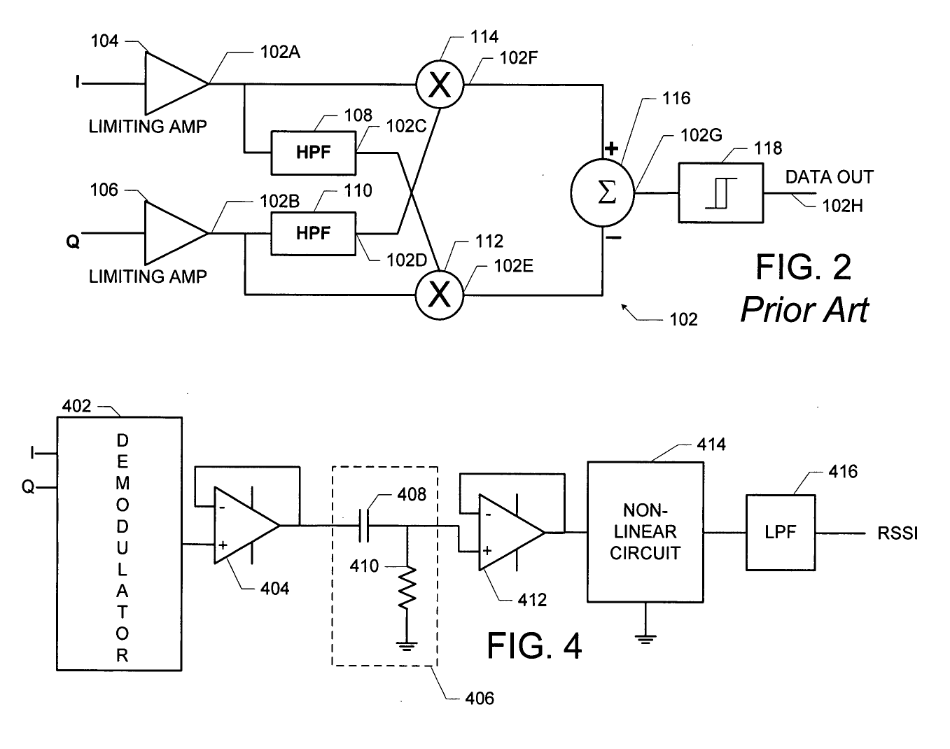

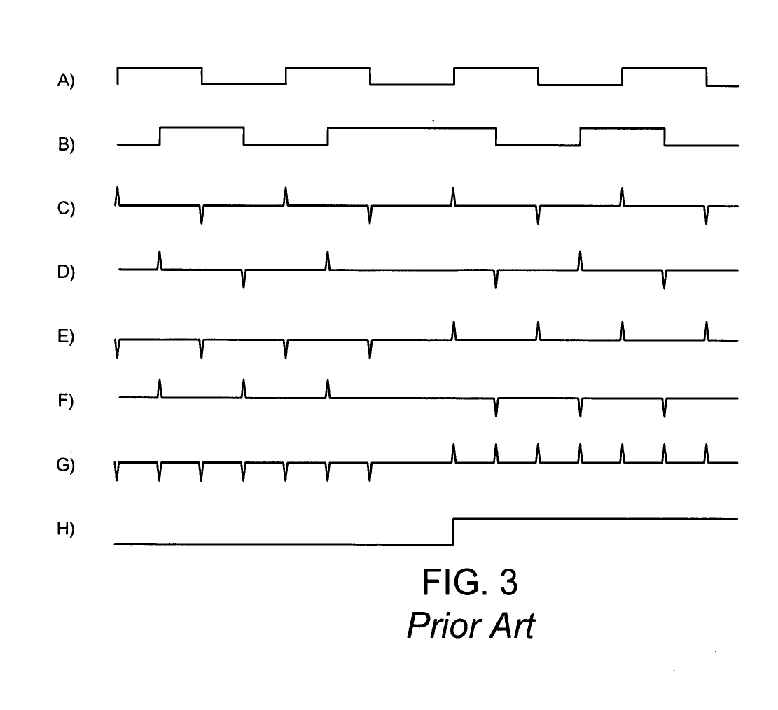

The I and Q channel baseband signals are then provided to the demodulator 102, which is depicted in FIG. 2. The I and Q baseband signals are limited by limiting amplifiers 104, 106. The limiting amplifiers clip the sinusoidal baseband signals, and ideally provide a square wave signal at points 102A, 102B, as shown in FIGS. 3A, 3B, respectively. The limiting, or clipping, of the input I and Q signals results in discontinuities in the clipped signals, which in turn generate high frequency energy. The clipped I and Q signals are then high-pass filtered by filters 108, 110, respectively, to extract the high frequency energy in the form of positive and negative pulses occurring at the transition points of the input I and Q signals. These are referred to herein as phase pulses, as the pulses provide information indicative of the signal transitions, and hence the phase of the baseband I and Q signals. The inphase phase pulses appear at point 102C, and are shown in FIG. 3C, while the quadrature phase pulses appear at point 102D, and are shown in FIG. 3D.

The inphase phase pulses are mixed, or multiplied by the clipped quadrature channel signal, and the quadrature phase pulse is mixed or multiplied by the clipped inphase channel signal, by multipliers 112, 114, respectively. The multiplication of the phase pulses by the opposite channel generates relative phase pulses. The relative phase pulses at the outputs 102E, 102F, of the mixers 112, 114, respectively, are shown in FIGS. 3E, 3F, respectively. The relative phase pulses are then combined by summer 116, whose output 102G is shown in FIG. 3G. The relative phase pulses are then operated on by a decision device 118, which may take the form of a hysteresis circuit such as a Schmidt trigger or other suitable circuit.

It was discovered that the degree of clipping by the limiting amplifiers 104, 106 results in signal artifacts that may be exploited to form a receive signal strength indication signal. In particular, the degree of clipping affects the nature of the discontinuity of the square wave signal at outputs 102A, 102B, and hence the amount of energy present in the phase pulses. Therefore, a measure of the power or magnitude of the phase pulses may be used as a measure of the receive signal strength. Because the peak amplitude of the pulse signal is proportional to the receive signal strength, the peak pulse amplitude may be used as a measure of the magnitude. Similarly, a low pass version of the signal amplitude may be used. In this regard, the “magnitude” of the pulses is meant to describe any voltage, current or power characteristic of the phase pulses that is proportional to the received signal strength.

In one embodiment, the method comprises the steps of (i) receiving inphase and quadrature baseband signals having a relative phase relationship indicative of data symbols; (ii) limiting the amplitude of the inphase and quadrature baseband signals; (iii) generating inphase pulses and quadrature pulses representative of signal amplitude transitions of the inphase and quadrature baseband signals; (iv) generating relative phase pulses representative of the relative phase between the inphase and quadrature baseband signals; (v) generating a data symbol output signal in response to the relative phase pulses; and (vi)generating a receive signal strength indicator (RSSI) signal proportional to the magnitudes of the inphase pulses and quadrature pulses.

There are various signals that may be operated on to form the RSSI signal. The RSSI may be generated from the inphase and quadrature pulses generated by the high-pass filters 108 or 110, or both. In addition, the relative phase pulses generated by mixers 110, 114, or the combined output 102G of the summer 116 may be used. As a further alternative, the data symbol output signal at output 102H may be used. Theoretically, the signal at output 102H is generally a square wave as shown in FIG. 3H. However, the inventors have discovered that the output of many demodulators also contain a voltage ripple signal proportional to the relative phase pulses, which in turn are proportional to the inphase and quadrature pulses.

One embodiment that operates on the data symbol output signal is shown in FIG. 4. The demodulator 402 provides a data symbol output signal to the voltage follower 404. The data symbol output signal is preferably high-pass filtered by filter 406 to remove the data symbol information, leaving only the voltage ripple. In one embodiment, the filter 406 comprises a capacitor 408 and resistor 410. The signal is fed to another voltage follower 412, which provides the signal to non-linear circuit 414.

To obtain the RSSI signal, the voltage ripple signal is preferably processed by a non-linear circuit 414 such as a rectifier, a squaring amplifier, or mixer. Either a full-wave or half-wave rectifier may be used. In particular, a Gilbert cell or four quadrant multiplier is preferably used for the non-linear circuit 414. The output of the non-linear circuit 414 is preferably a direct current signal that may then be low pass filtered by low-pass filter 416 to determine a measure of the magnitude of the pulses. In an alternative embodiment, the non-linear circuit may include an analog to digital converter, whose output may be collected and processed by a digital signal processor that may perform squaring, or by a digital circuit such as an accumulator or arithmetic logic unit that performs peak detection and/or numerical averaging.

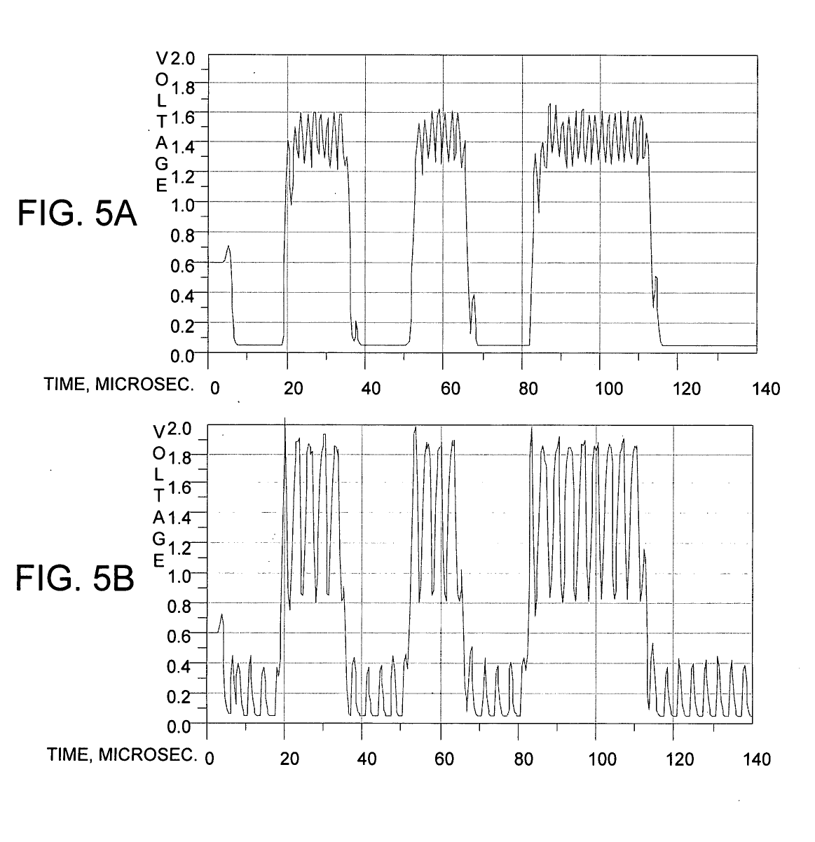

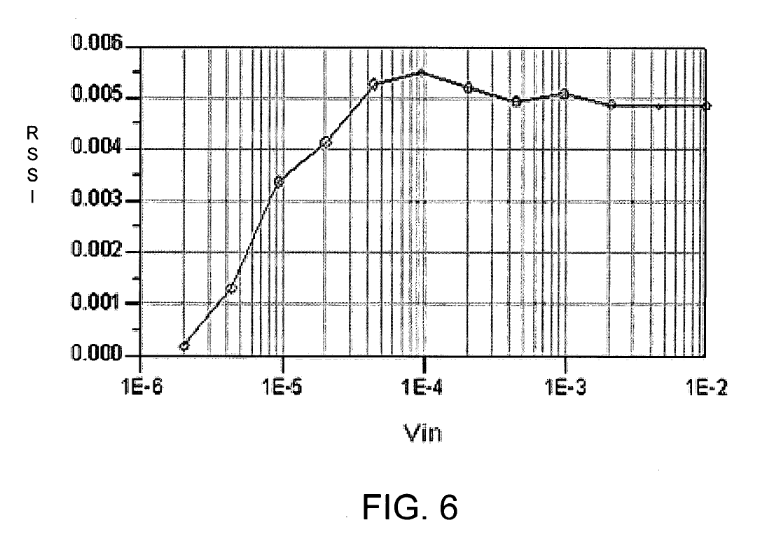

Two data symbol output signals from demodulator 402 are shown in FIGS. 5A and 5B. The input voltage of the I and Q signals that generated the data symbol output signal in FIG. 5A was 4.34 micro volts, while the input voltage of the I and Q signals that generated the data symbol output signal in FIG. 5B was 96.0 micro volts. As shown in FIGS. 5A and 5B, the data symbol output signal contains a ripple voltage that is proportional to the phase pulses generated with the demodulator. The relationship between the I and Q baseband input signals and the RSSI signals generated from the embodiment of FIG. 4 are shown in FIG. 6. FIG. 6 demonstrates that the RSSI signal generation circuit of FIG. 4 provides a good measure of receive signal strength over a broad range of I and Q channel input signal voltages.

In alternative embodiments, an apparatus for generating a receive signal strength measurement is provided. The apparatus preferably includes a frequency shift keyed demodulator that generates a data symbol output signal in response to relative phase pulses representative of the relative phase relationship between inphase and quadrature baseband signals, and a non-linear circuit for generating a receive signal strength indication signal proportional to the magnitude of the relative phase pulses.

The non-linear circuit may be a voltage rectifier, current rectifier, a current or voltage squaring circuit, a mixer, or other circuit that generates a direct current output signal. The non-linear circuit may operate directly on the inphase and quadrature pulses generated from a clipping operation (performed by e.g., limiting amplifiers 104, 106) on the inphase and quadrature channels. Alternatively, the relative phase pulses generated by the multipliers 112, 114 may be used.

An exemplary embodiment of the invention has been described above. Those skilled in the art will appreciate that changes may be made to the embodiment described without departing from the true spirit and scope of the invention as defined by the claims.

We claim:

1. A method of obtaining a receive signal strength measurement from an FSK demodulator signal output, comprising the steps:
receiving inphase and quadrature baseband signals having a relative phase relationship indicative of data symbols;
limiting the amplitude of the inphase and quadrature baseband signals;
generating inphase pulses and quadrature pulses representative of signal amplitude transitions of the inphase and quadrature baseband signals;
generating relative phase pulses representative of the relative phase between the inphase and quadrature baseband signals;
generating a data symbol output signal in response to the relative phase pulses; and,
generating a receive signal strength indicator signal proportional to the magnitudes of the inphase pulses and quadrature pulses.

2. The method of claim 1, wherein the step of generating inphase pulses and quadrature pulses is performed by high-pass filtering the inphase and quadrature baseband signals.

3. The method of claim 1, wherein the step of generating a receive signal strength indicator signal is performed by rectifying and filtering the inphase and quadrature pulses.

4. The method of claim 1, wherein the step of generating a receive signal strength indicator signal is performed by squaring and filtering the inphase and quadrature pulses.

5. The method of claim 1, wherein the step of generating a receive signal strength indicator signal is performed by rectifying and filtering the relative phase pulses.

6. The method of claim 1, wherein the step of generating a receive signal strength indicator signal is performed by squaring and filtering the relative phase pulses.

7. The method of claim 1, wherein the data symbol output signal is a square wave that contains a voltage ripple signal proportional to the inphase and quadrature pulses, and wherein the step of generating a receive signal strength indicator signal is performed by determining the magnitude of the voltage ripple signal.

8. The method of claim 7, wherein the step of generating a receive signal strength indicator signal further comprises high-pass filtering the data symbol output signal prior to determining the magnitude of the voltage ripple signal.

9. The method of claim 8, wherein the step of determining the magnitude of the voltage ripple signal comprises rectifying and low-pass filtering the high-pass filtered data symbol output signal.

10. The method of claim 8, wherein the step of determining the magnitude of the voltage ripple signal comprises squaring and low-pass filtering the high-pass filtered data symbol output signal.

11. An apparatus for generating a receive signal strength measurement in an frequency shift keyed communication system, comprising:
a frequency shift keyed demodulator that generates a data symbol output signal in response to relative phase pulses representative of the relative phase relationship between inphase and quadrature baseband signals; and,
a non-linear circuit for generating a receive signal strength indication signal proportional to the magnitude of the relative phase pulses.

12. The apparatus of claim 1 1, wherein the non-linear circuit is a voltage rectifier.

13. The apparatus of claim 11, wherein the non-linear circuit is a voltage squaring circuit.

14. The apparatus of claim 11, wherein the non-linear circuit operates on a square wave data symbol output signal of the demodulator, wherein the square wave data symbol output signal contains a voltage ripple signal proportional to the magnitude of the relative phase pulses, and wherein the non-linear circuit further comprises a high-pass filter for removing the square wave component of the square wave data symbol output signal.

15. The apparatus of claim 14, wherein the non-linear circuit comprises a voltage rectifier followed by a low-pass filter.

16. The apparatus of claim 14, wherein the non-linear circuit comprises a voltage squaring circuit followed by a low-pass filter.

17. A method of generating a receive signal strength indicator signal from an FSK demodulator signal output, wherein the demodulator clips inphase and quadrature input signals and generates an output signal containing high frequency pulses representative of the relative phase of the inphase and quadrature channels, the method comprising the steps:
forming a direct current signal containing the high frequency pulses representative of the relative phase of the inphase and quadrature channels;
filtering the direct current signal; and
providing a receive signal strength signal indicator signal in response to the filtered direct current signal.

18. The method of claim 17, wherein the direct current signal is formed by rectifying the output signal.

19. The method of claim 17, wherein the direct current signal is formed by squaring the output signal.

20. The method of claim 17 wherein the direct current signal is formed in response to the clipped inphase and quadrature input signals.
